(19) United States
(12) Patent Application Publication
(10) Pub. No.: US 2009/0279389 A1
(43) Pub. Date: Nov. 12, 2009

(54) ULTRASONIC SIGNAL COMMUNICATION DEVICE, COMMUNICATION DEVICE, COMMUNICATION DEVICE FOR DIVERS, COMMUNICATION SYSTEM, AND COMMUNICATION METHOD

(75) Inventor: Michio IRIE, Suwa (JP)

Correspondence Address: GLOBAL IP COUNSELORS, LLP, 1233 20TH STREET, NW, SUITE 700, WASHINGTON, DC, 20036-2680, US

(73) Assignee: SEIKO EPSON CORPORATION, Tokyo (JP)

(21) Appl. No.: 12/433,426

(22) Filed: Apr. 30, 2009

(30) Foreign Application Priority Data
May 9, 2008 (JP) 2008-123019
Jul. 4, 2008 (JP) 2008-175355
Feb. 17, 2009 (JP) 2009-033592

(51) Int. Cl. G01S 3/80; H04B 11/00

(52) U.S. Cl. 367/118; 367/131

(57) ABSTRACT

An ultrasonic signal communication device that has an ultrasonic oscillation unit that has at least two resonance frequencies according to the oscillation mode, a transmission unit that generates a first ultrasonic signal at one of the two resonance frequencies and transmits the generated first ultrasonic signal from the ultrasonic oscillation unit, and a reception unit that receives from the ultrasonic oscillation unit a second ultrasonic signal that is transmitted at the other of the two resonance frequencies.

### BACKGROUND

1. Field of Invention

The present invention relates to a device for sending and receiving ultrasonic signals.

2. Description of Related Art

Communication devices enabling divers underwater to communicate with other divers and with the surface vessel are one example of a device for sending and receiving ultrasonic signals. Such communication devices are used to assure diver safety while underwater, and to enable divers to communicate with each other. Japanese Unexamined Patent Appl. Pub. JP-A-H11-74848 teaches an underwater communication device using ultrasonic signals as one type of ultrasonic signal communication device, and Japanese Unexamined Patent Appl. Pub. JP-A-H10-268049 teaches a device for measuring the distance to a target by means of underwater communication using ultrasonic signals.

A problem with both ultrasonic signal communication devices taught as communication devices in the related art cited above is that two frequencies must be used to enable full-duplex communication between two underwater communication devices, and each underwater communication device or communication device requires two channels, including two oscillators, an ultrasonic oscillator compatible with the transmission frequency and an ultrasonic oscillator compatible with the reception frequency, and circuits for controlling both ultrasonic oscillators. Because a two-channel configuration is required for the ultrasonic oscillators, the device configuration is complicated and large. More particularly, reducing the size and the manufacturing cost of these underwater communication devices is difficult.

### SUMMARY

The present invention is directed to solving the foregoing problem by simplifying the configuration of the ultrasonic signal communication device.

The present invention solves at least part of the problem described above, and is an ultrasonic signal communication device having an ultrasonic oscillation unit that has at least two resonance frequencies according to the oscillation mode, a transmission unit that generates a first ultrasonic signal at one of the two resonance frequencies and transmits the generated first ultrasonic signal from the ultrasonic oscillation unit, and a reception unit that receives a second ultrasonic signal that is transmitted at the other of the two resonance frequencies from the ultrasonic oscillation unit.

### BRIEF DESCRIPTION OF THE DRAWINGS

FIG. 1 shows the functional configuration of a communication system including a communication device that is an ultrasonic signal communication device according to a first embodiment of the invention.

FIG. 2 shows the hardware configuration of the communication device.

FIG. 3 shows a dive computer as an embodiment of an ultrasonic signal communication device according to a second embodiment of the invention, FIG. 3A being a block diagram describing the configuration of the dive computer, and FIG. 3B being a block diagram describing the configuration of the communication unit of the dive computer.

FIG. 4 is a frontal view of the dive computer.

FIG. 5 shows an example of content displayed on the display unit of the dive computer when two people are diving.

FIG. 6A is an oblique view describing the appearance of the ultrasonic oscillator, FIG. 6B describes the gain characteristic of the ultrasonic oscillator, and FIG. 6C describes ultrasonic signal propagation loss.

FIG. 7 is a block diagram describing the configuration of the transmitter.

FIG. 8 shows the appearance of the transmitter.

FIG. 9 describes communication between the devices when two people are diving.

FIG. 10A describes the relative positions of the dive computer and transmitter when pairing, and FIG. 10B describes the relative positions of the dive computers when pairing.

FIG. 11 is a graph showing another example of the gain characteristic of the ultrasonic oscillator.

FIG. 12A describes a disk-shaped ultrasonic oscillator, and FIG. 12B describes a rectangular ultrasonic oscillator.

FIG. 13 describes another example of communication between the devices when two people are diving.

FIG. 14 schematically describes a distance measuring device as an ultrasonic signal communication device according to a third embodiment of the invention.

FIG. 15 is a function block diagram of the distance measuring device according to the third embodiment of the invention.

### DESCRIPTION OF PREFERRED EMBODIMENTS

### CLASSIFICATION OF THE INVENTION

In addition to the primary aspect of the invention described above, ultrasonic signal communication devices with the features and characteristics described below are also included in the scope of the present invention. The features of these ultrasonic signal communication devices are described below, and other actions and effects are added as necessary. In order to simplify the following description of the embodiments of the invention, the description of the invention is divided for convenience into the following first to fourth aspects of the invention according to the main components or categories (device, system, method) of the invention.

### FIRST ASPECT OF THE INVENTION

The ultrasonic signal communication device according to a first aspect of the invention is a communication device, the first ultrasonic signal and the second ultrasonic signal are communication signals, and it has a control unit that asynchronously controls transmission by the first transmission unit and reception by the reception unit.

This aspect of the invention transmits the first communication signal at one frequency of the two resonance frequencies according to the oscillation mode of the ultrasonic oscillation unit, receives the second communication signal at the other frequency, and asynchronously controls transmission and reception. The size and production cost of the communication device can therefore be reduced because the communication device can send and receive signals of different frequencies using a single ultrasonic oscillation unit in a full-duplex mode.

The communication device has a filter unit that selectively passes a signal of a specific frequency band at least between the ultrasonic oscillation unit and the transmission unit, or between the ultrasonic oscillation unit and the reception unit.

This aspect of the invention improves the quality of the communication signal by selectively passing a communication signal of a desired frequency band.

A matching unit that matches impedance is disposed at least between the ultrasonic oscillation unit and the transmission unit, or between the ultrasonic oscillation unit and the reception unit.

This aspect of the invention improves the quality of the communication signal because impedance can be matched by providing a matching unit.

### SECOND ASPECT OF THE INVENTION

A second aspect of the invention is characterized by providing in the main invention a second reception unit that receives the first ultrasonic signal from the ultrasonic oscillation unit, and a second transmission unit that transmits the second ultrasonic signal by means of the ultrasonic oscillation unit. This ultrasonic signal communication device communicates with different devices for each two resonance frequencies of the ultrasonic oscillation unit, and the device configuration can therefore be simplified.

The ultrasonic signal communication device is a communication device, the first ultrasonic signal and the second ultrasonic signal are communication signals, and it has a communication unit that communicates with a different type of communication device than said communication device using one of the resonance frequencies, and communicates with a communication device of the same type as said communication device using the other resonance frequency.

Also, the communication device is characterized by the communication unit communicating using a resonance frequency of an oscillation mode in the thickness direction of the ultrasonic oscillation unit and a resonance frequency of an oscillation mode in a direction of intersection intersecting the thickness direction.

This communication device can communicate reliably with other devices because it uses a resonance frequency of an oscillation mode in the thickness direction and a resonance frequency of an oscillation mode in a direction of intersection.

The resonance frequency of the oscillation mode in the thickness direction is higher than the resonance frequency of the oscillation mode in the direction of intersection. This aspect of the invention is suited to reducing the size of the device because the thickness of the ultrasonic oscillation unit can be made thin.

In the communication device according to the foregoing second aspect of the invention the communication unit uses the resonance frequency with the lower gain characteristic of the two resonance frequencies for communication at a shorter distance.

The communication device is a divers communication device, and the communication unit communicates with a tank using one resonance frequency and communicates with another divers communication device using the other resonance frequency.

In the divers communication device the communication unit communicates with the tank using the resonance frequency with the lower gain characteristic of the two resonance frequencies.

Efficiency is good with this divers communication device because the resonance frequency with the lower gain characteristic is used for communication with the tank, which is often closer than the other divers communication device. With this divers communication device efficiency is good because the resonance frequency that attenuates more easily in water is used for communication with the tank, which is usually closer than the other divers communication device.

The divers communication device also has a display unit that displays residual amount information sent from the tank and residual amount information sent through the other divers communication device. Problems of insufficient residual capacity can be suppressed with this divers communication device because residual amount information for the tank is displayed.

### THIRD ASPECT OF THE INVENTION

The invention also includes a communication system and a communication method. The third aspect of the invention relates to this communication system and communication method, and includes a communication system and a communication method corresponding to the foregoing first and second aspects of the invention described above.

The aspect of the invention related to this communication system is a communication system for communicating between a plurality of communication devices, wherein one communication device has an ultrasonic oscillation unit that has at least two resonance frequencies according to the oscillation mode, a transmission unit that generates a first communication signal at one of the two resonance frequencies and transmits the generated first communication signal from the ultrasonic oscillation unit, and a reception unit that receives from the ultrasonic oscillation unit a second communication signal that is transmitted at the other of the two resonance frequencies; another communication device has an ultrasonic oscillation unit that has at least the two resonance frequencies according to the oscillation mode, a transmission unit that generates the second communication signal at the other of the two resonance frequencies and transmits the generated second communication signal from the ultrasonic oscillation unit, and a reception unit that receives from the ultrasonic oscillation unit the first communication signal that is transmitted at the one of the two resonance frequencies; and of the two resonance frequencies, the gain characteristic of one frequency is lower than the gain characteristic of the other frequency, and the one communication device has a higher signal output level than the other communication device.

A communication system in which, of the two resonance frequencies, the propagation loss of one frequency is greater than the propagation loss of the other frequency, and the one communication device has a higher signal output level than the other communication device.

The communication method according to this aspect of the invention has a transmission step of generating a first communication signal and transmitting the generated first communication signal from one ultrasonic oscillation unit at one frequency of two resonance frequencies corresponding to the oscillation modes of the ultrasonic oscillation unit; and a reception step of receiving from the ultrasonic oscillation unit a second communication signal transmitted at the other frequency of the two resonance frequencies.

A communication system including the divers communication device according to the second aspect of the invention is also included in this third aspect of the invention. This communication system is a communication system that has a tank communication device attached to a tank, and a divers communication device worn by a diver, wherein the divers communication device has an ultrasonic oscillation unit that has at least two resonance frequencies corresponding to the oscillation modes; and a communication unit that communicates with the tank communication device using one resonance frequency of the two resonance frequencies, and communicates with another divers communication device using the other resonance frequency of the two resonance frequencies.

A communication method using the divers communication device according to another aspect of the invention is a communication method for communicating between a divers communication device worn by one diver, a tank used by the one diver, and another divers communication device worn by another diver, wherein communication with the tank uses one resonance frequency of the at least two resonance frequencies produced by an ultrasonic oscillation unit, and communication with the other divers communication device uses the other resonance frequency of the two resonance frequencies.

### FOURTH ASPECT OF THE INVENTION

A fourth aspect of the invention uses an ultrasonic signal in a dinstance-gauging application, the main aspect of the invention having a dinstance-gauging unit that measures the distance to a transmission signal source based on a time difference between when the second ultrasonic signal is transmitted and when the second ultrasonic signal is received by the reception unit.

This fourth aspect of the invention can also be rendered as an ultrasonic signal communication device having a second transmission unit that transmits the second ultrasonic signal by means of the ultrasonic oscillation unit; and a transmission/reception switching unit that switches between a transmission process of transmitting the second ultrasonic signal by means of the second transmission unit, and a reception process of receiving the second ultrasonic signal by means of the reception unit.

### Embodiments

### First Embodiment

The first embodiment of the invention described below is an embodiment of the first aspect of the invention described above. A communication system including two communication devices is described below.

### Working Model

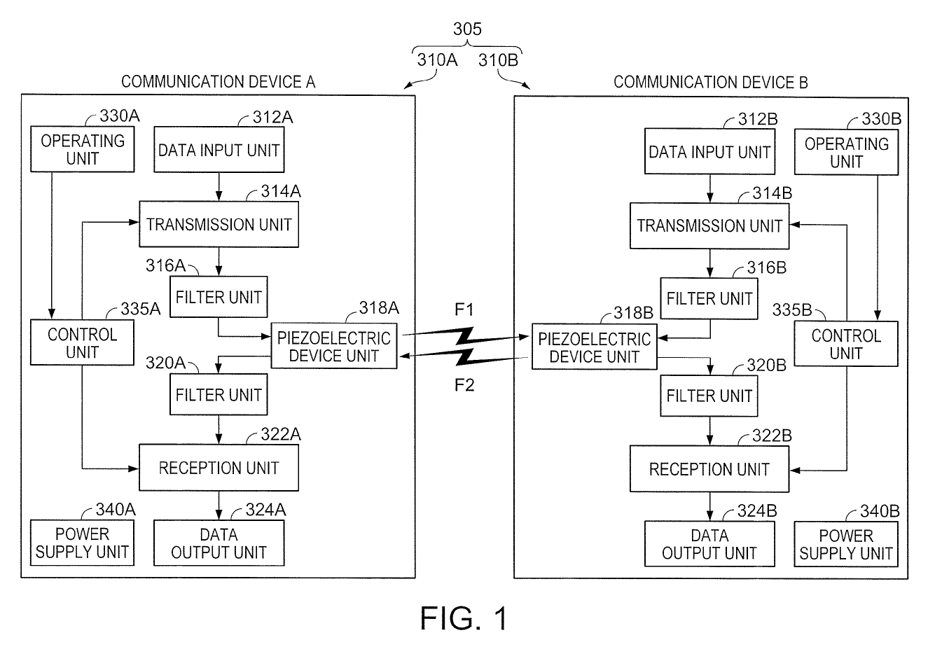

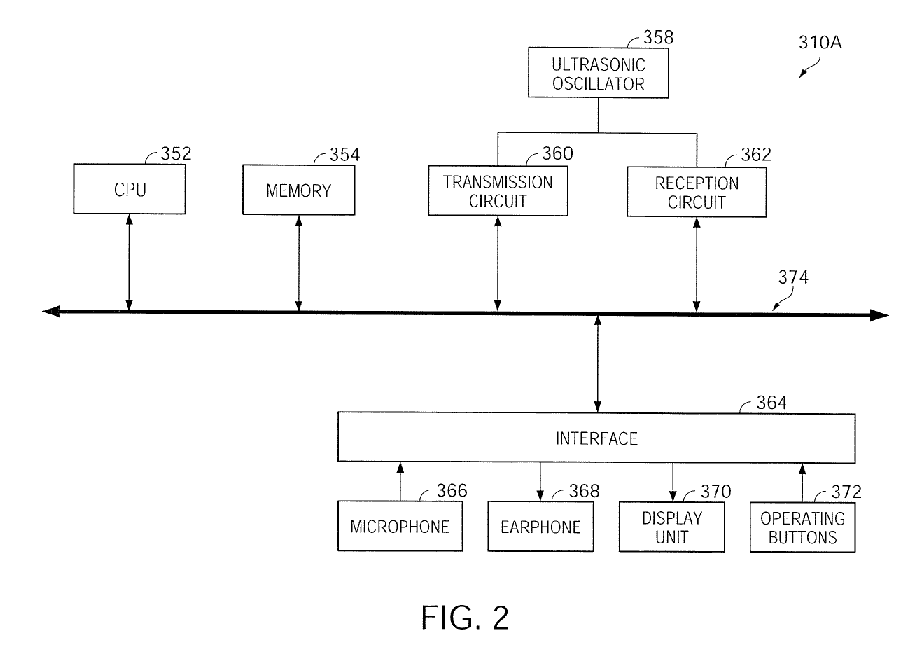

FIG. 1 shows the functional configuration of a communication system 305. This communication system 305 includes one communication device A 310A and another communication device B 310B, and anticipates full-duplex underwater communication by means of communication between the communication devices using ultrasonic signals. Note that while the communication device A 310A and communication device B 310B transmit and receive opposite frequencies, they both have the same functional configuration and hardware configuration, and the function units of the communication device A 310A are therefore described below by way of example. FIG. 2 shows the hardware configuration of the communication device A 310A, and is therefore also referred to below.

The communication device A 310A has a data input unit 312A, a transmission unit 314A, a filter unit 316A, a piezoelectric device unit 318A, a filter unit 320A, a reception unit 322A, a data output unit 324A, an operating unit 330A, a control unit 335A, and a power supply unit 340A, and is rendered in a case not shown that is water-resistant and water-pressure resistant.

The hardware components of the communication device A 310A include a CPU (central processing unit) 352, memory 354, transmission circuit 360, reception circuit 362, and interface 364, which are connected to a bus 374 enabling communication therebetween. One ultrasonic oscillator 358 is connected to the transmission circuit 360 and reception circuit 362, and a microphone 366, earphone 368, display unit 370, and operating buttons 372 are connected to the interface 364.

Data to be sent to the communication device B 310B, that is, the other terminal, is input to the data input unit 312A. The data input unit 312A in this embodiment of the invention is the microphone 366, which is located near the mouth of the person holding the communication device A 310A. Sounds uttered by this person are converted to a data signal and sent to the transmission unit 314A. Data input to the data input unit 312A is not limited to audio data, and may be data related to the physical condition of the person with the communication device A 310A, such as the persons pulse rate or blood pressure, or even various kinds of informational data input by the person.

The transmission unit 314A generates a communication signal at a specified transmission frequency F1, and sends the generated communication signal from the piezoelectric device unit 318A. More specifically, the transmission unit 314A applies a specific modulation process to the data signal sent from the data input unit 312A, frequency converts the modulated signal, amplifies the signal to a specific output level, and sends the signal as a radio frequency signal of frequency F1 to the piezoelectric device unit 318A. The modulation method is not specifically limited, and Frequency Shift Keying (FSK), for example, can be used. In this embodiment of the invention the transmission unit 314A is rendered by the transmission circuit 360. Note that of the frequencies F1 and F2, the transmission unit 314A may generate the signal of the higher frequency by upconverting the signal of the lower frequency.

The filter unit 316A is disposed between the transmission unit 314A and piezoelectric device unit 318A. The filter unit 316A is a bandpass filter, and functions to remove unnecessary frequency components and selectively pass a high frequency signal of a specific frequency band centered on the frequency F1 of the high frequency signal input from the transmission unit 314A. The filter unit 316A is rendered by the transmission circuit 360 in this embodiment of the invention. Note that a matching unit (not shown in the figure) for matching the impedance of the transmission unit 314A and piezoelectric device unit 318A may be inserted in place of this filter unit 316A, or the filter unit 316A and a matching unit may be disposed in series. A configuration in which neither the filter unit 316A or matching unit is inserted is also conceivable.

The piezoelectric device unit 318A is an ultrasonic wave oscillation unit that has at least two resonance frequencies according to the oscillation mode. In this embodiment of the invention an ultrasonic oscillator 358 that sends and receives ultrasonic signals by means of elastic oscillation is used as the piezoelectric device unit 318A. When a piezoelectric device having two electrodes disposed on opposite sides of a ceramic piezoelectric body detects ultrasonic vibration, the ultrasonic oscillator 358 converts the ultrasonic vibration to and outputs a high frequency signal. When a high frequency signal is input, the ultrasonic oscillator 358 generates and emits ultrasonic oscillation according to the high frequency signal. The shape of the piezoelectric device is, for example, a cylindrical body of a specific thickness, and the resonance frequency is determined by the specific elastic oscillation determined by the shape of the piezoelectric body.

Of the many different oscillation modes, this embodiment of the invention uses two, an oscillation mode in the radial direction and an oscillation mode in the thickness direction. More specifically, the ultrasonic oscillator 358 uses either the resonance frequency of the radial oscillation mode or the resonance frequency of the thickness oscillation mode as frequency F1 and uses the other resonance frequency as frequency F2. This embodiment of the invention anticipates a donut-shaped cylindrical piezoelectric body with a diameter of 5 mm that produces a frequency F1 of 400 kHz and a frequency F2 of 1.3 MHz. Because the center frequency is 900 kHz with this configuration, signals of frequencies F1 and F2 are isolated and free of mutual interference. Therefore, the high frequency signal of frequency F1 output from the transmission unit 314A is converted to an ultrasonic signal carrying information as the communication signal, and is emitted into the surrounding water from the communication device A 310A. The ultrasonic signal of frequency F2 emitted from the other communication device B 310B similarly containing information as the communication signal is detected by the piezoelectric device unit 318A, converted to a high frequency signal, and passed to the filter unit 320A.

The filter unit 320A is inserted between the piezoelectric device unit 318A and reception unit 322A. The filter unit 320A is a bandpass filter identical to the one filter unit 316A, and functions to remove unnecessary frequency components by selectively passing a high frequency signal with a specific bandwidth centered on the frequency F2 of the high frequency signal converted by the piezoelectric device unit 318A. In this embodiment of the invention the filter unit 320A is part of the reception circuit 362. Note that a matching unit (not shown in the figure) for matching the impedance of the reception unit 322A and piezoelectric device unit 318A may be inserted in place of this filter unit 320A, or the filter unit 320A and a matching unit may be disposed in series. A configuration in which neither the filter unit 320A or matching unit is inserted is also conceivable.

The reception unit 322A receives the high frequency signal of frequency F2 sent from the piezoelectric device unit 318A. More specifically, the reception unit 322A extracts the modulated signal from the high frequency signal F2 sent from the piezoelectric device unit 318A, and gets the information signal superposed on the modulated signal by demodulating the extracted modulated signal. The acquired information signal is sent to the data output unit 324A. Note that in this embodiment of the invention the reception unit 322A is rendered by the reception circuit 362. In addition, the reception unit 322A generates the signal of the lower frequency F1 or F2 by down-converting the signal of the higher frequency.

The data output unit 324A outputs the information signal acquired by the reception unit 322B. In this embodiment of the invention the data output unit 324A anticipates an earphone 368 that converts the data signal to audio. This earphone 368 is worn on the ear of the person having the communication device A 310A. Note that the invention is not limited to audio output, and an image may be displayed on the display unit 370 depending on the information contained in the data signal.

The control unit 335A asynchronously controls transmission by the transmission unit 314A and reception by the reception unit 322A. In other words, transmission by the transmission unit 314A and reception by the reception unit 322A may occur simultaneously or only one may occur at a time. As a result, transmission and reception are possible in a full-duplex mode. In this embodiment of the invention the CPU 352 controls operation of the transmission circuit 360 and the reception circuit 362 by executing a specific program stored in memory 354.

The operating unit 330A is operated by the person with the communication device A 310A, and controls operation of the communication device A 310A. In this embodiment of the invention operating buttons 372 are disposed to the communication device A 310A as the operating unit 330A, and the person with the communication device A 310A operates the operating buttons 372 according to the information displayed on the display unit 370.

The power supply unit 340A supplies power to the function units of the communication device A 310A. In this embodiment of the invention the power supply unit 340A is a rechargeable storage battery.

The communication device B 310B has the same functions as the communication device A 310A described above, the transmission unit 314B operates on frequency F2, and the reception unit 322B operates on frequency F1. The person with communication device A 310A and the person with communication device B 310B can therefore communicate with each other underwater by means of full-duplex communication.

As described above, the foregoing embodiment of the invention enables full-duplex ultrasonic communication using one ultrasonic oscillator 358 by using two resonance frequencies that differ according to the oscillation mode of the single ultrasonic oscillator 358 for transmission and reception. The number of parts rendering the communication device A 310A can therefore be reduced because the communication device A 310A requires only one ultrasonic oscillator 358. As a result, the production cost can be reduced in addition to rendering the communication device A 310A smaller and lighter.

This embodiment of the invention is described above with reference to accompanying figures, but the specific configuration of the invention is not limited to this embodiment and includes various design modifications that do not depart from the scope of the invention. For example, the configurations of the communication device A 310A and communication device B 310B may the same or different. For example, though not shown in the figures, the communication device A 310A may be rendered like a wristwatch in a size that can be worn by the diver, and the communication device B 310B could be mounted on the surface vessel with the piezoelectric device unit 318B separated therefrom and exposed underwater. Because the size of the communication device B 310B can be increased in this configuration, the output signal strength can be increased compared with the communication device A 310A by increasing the power supply capacity of the power supply unit 340B. Therefore, when the gain characteristic varies according to the frequency, a drop in the gain characteristic can be improved by outputting a strong signal by setting frequency F1 as a frequency with a good gain characteristic setting frequency F2 as a frequency with a poor gain characteristic. In addition, propagation loss increases as the frequency increases in the frequency range (several 10 kHz to several MHz) that is used for underwater ultrasonic communication. Therefore, by setting frequency F2 to a higher frequency than frequency F1, the increase in propagation loss can be improved by strong signal output.

In the foregoing embodiment of the invention the communication system 305 operates in a full-duplex communication mode, but half-duplex communication is also possible by the communication device A 310A and communication device B 310B switching between transmission and reception. Because the two frequencies F1 and F2 switch during transmission and reception, the effect of reflection echoes caused by the transmitted ultrasonic signal bouncing off the sea floor, underwater rocks, vessels, or other objects and being picked up at a delay can be eliminated.

Furthermore, the communication system 305 in this embodiment of the invention is composed of a communication device A 310A and a communication device B 310B, but is not limited to two communication devices and may include three or more devices. In this application the communication device A 310A, for example, could be used as a primary communication device that communicates with a plurality of secondary communication devices B, C for communicating between one primary and plural secondary devices. Further alternatively, there may be a plurality of primary devices.

### Second Embodiment

A second embodiment of the invention is described next as an embodiment of the second aspect of the invention described above. More specifically, this embodiment of the invention is a communication system including a dive computer as a type of diver communication device, and a transmitter attaced to an air tank (as a type of tank communication device).

### Dive Computer 1

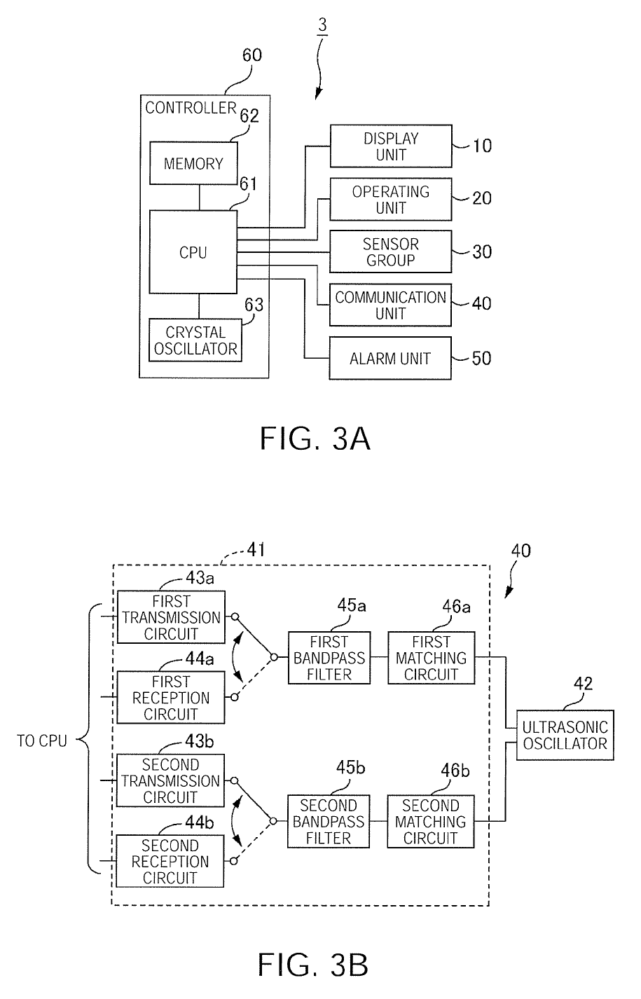

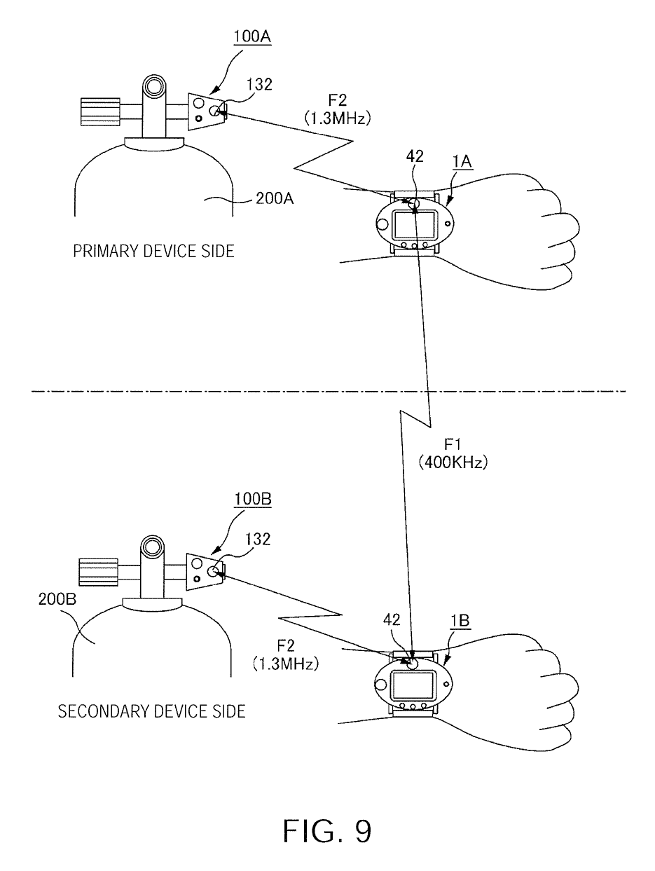

As shown in FIG. 3A, a dive computer 1 according to this embodiment of the invention has a display unit 10, an operating unit 20, a sensor group 30, a communication unit 40, an alarm unit 50, and a controller 60. The dive computer 1 is worn on the wrist of the diver (user) similarly to a wristwatch (see FIG. 9), and is also used as a diver watch.

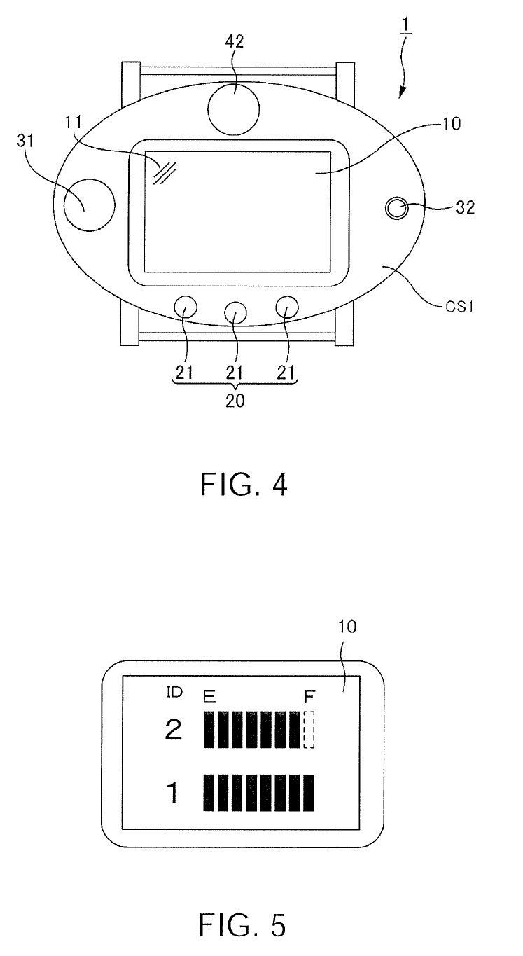

The display unit 10 is the part that displays information for the diver, and may be rendered using a variety of display devices. For example, a liquid crystal display device or an LED display device may be used. As shown in FIG. 4, the display unit 10 is housed inside a case CS1 covered by a transparent member 11 of glass or plastic, for example. The diver can see the displayed content through the transparent member 11. As shown in FIG. 5, this dive computer 1 displays how much air remains in the air tank 200 (see FIG. 8) to the diver wearing the dive computer 1 and to other companion divers. This aspect is described further below.

The operating unit 20 is the part that is manipulated by the diver to cause the dive computer 1 to execute particular operations. As shown in FIG. 4, this dive computer 1 has three operating buttons 21 disposed side by side on the front of the case CS1 at approximately the 6:00 o'clock position (the position corresponding to 6:00 o'clock on the dial of an analog wristwatch)

The sensor group 30 is rendered by a plurality of different types of sensors. The detection results are output to the controller 60. These sensors include a pressure sensor 31 and an in-water sensor 32 for detecting the environment in which the dive computer 1 is being used.

The pressure sensor 31 outputs a detection signal according to the pressure of the environment in which the dive computer 1 is located. More particularly, the pressure sensor 31 outputs a detection signal according to the water pressure while diving. Because water pressure changes according to depth, the controller 60 can also recognize the water depth based on the detection signal. This pressure sensor 31 is disposed on the front of the case CS1 at the 9:00 o'clock position, for example, as shown in FIG. 4.

The in-water sensor 32 detects if the dive computer 1 is wet from water exposure. The in-water sensor 32 outputs a detection signal while diving indicating if the dive computer 1 is in the water. The in-water sensor 32 has two terminals, and outputs a detection signal indicating that the in-water sensor 32 is wet when the terminals are shorted through water. Note that as shown in FIG. 4 one of the terminals is disposed on the front of the case CS1 at the 3:00 o'clock position. The other terminal is a metal part of the case CS1, and is disposed electrically isolated from the first terminal.

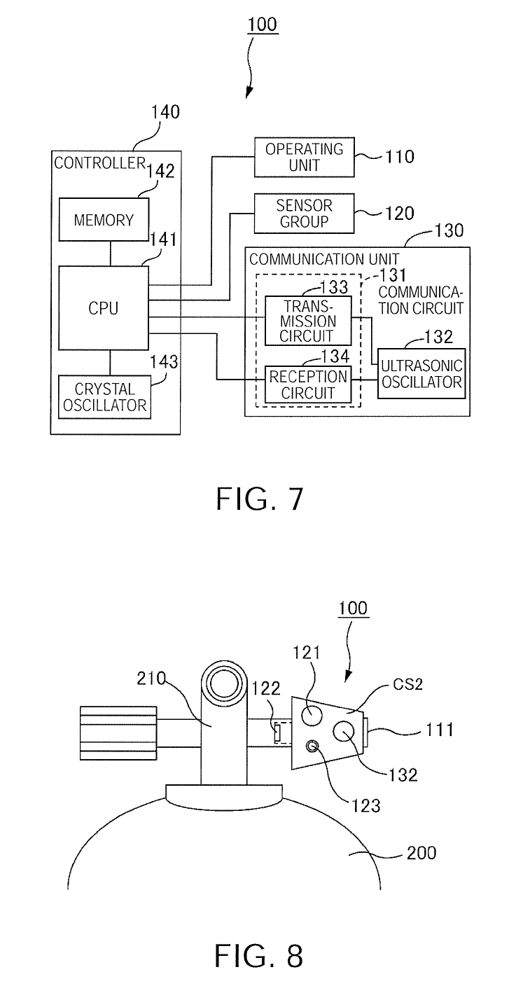

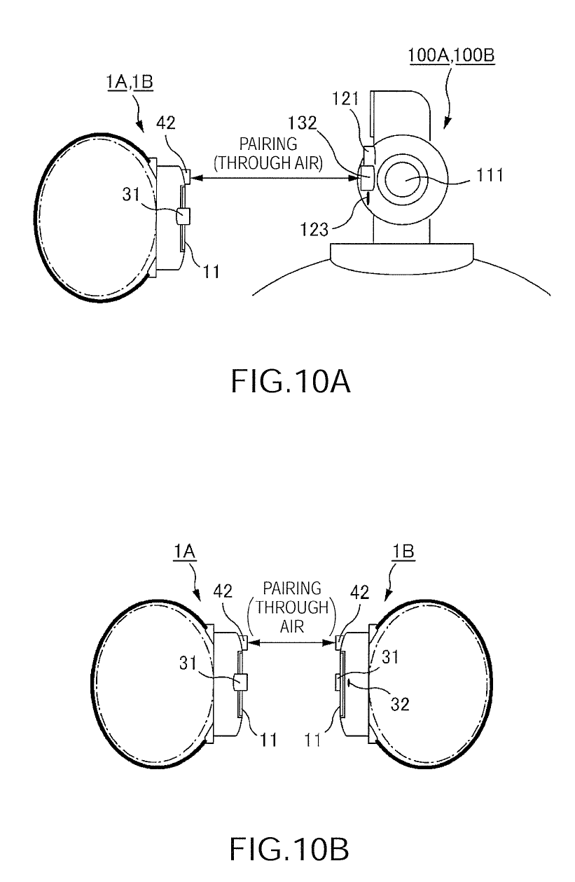

The communication unit 40 is the part for communicating data signals with other devices. This dive computer 1 communicates with the transmitter 100 (see FIG. 7) and other dive computers 1. These devices can communicate through both air and water. As shown in FIG. 10A and FIG. 10B, for example, the dive computers 1 can pair with each other while on land or on ship, that is, through air. As shown in FIG. 9, the dive computer 1 communicates the reserve gas capacity of the air tank 200 while in water. Note that pairing is a process of recognizing the companion communication device and synchronizing the control time, the clock timing, and the data signal communication timing. The communication unit 40 is described further below.

The alarm unit 50 is a part that issues alarms, is may be rendered by a vibrator, for example. This alarm unit 50 informs the diver that a problem occurred when a problem is detected. The alarm unit 50 is therefore not limited to a vibrator, and may be any device that can report to the diver. If a vibrator is used as the alarm unit 50, the diver can know without looking that a problem occurred and take immediate action.

The controller 60 is that part at the center of dive computer 1 control, and includes a CPU 61, memory 62, and a crystal oscillator 63. The CPU 61 operates according to firmware stored in memory 62 and controls the other controlled parts. For example, to display particular content, the CPU 61 outputs a display control signal to the display unit 10. It also communicates data signals as described above. The crystal oscillator 63 generates a reference clock signal for the dive computer 1. This crystal oscillator 63 operates in conjunction with an oscillation circuit incorporated in the CPU 61. The controller 60 also generates time information for the dive computer 1 based on the clock generated by the crystal oscillator 63.

### Communication Unit 40

As shown in FIG. 3B, the communication unit 40 includes a communication circuit 41 and an ultrasonic oscillator 42. The communication circuit 41 includes a first transmission circuit 43a, a second transmission circuit 43b, a first reception circuit 44a, a second reception circuit 44b, a first bandpass filter 45a, a second bandpass filter 45b, a first matching circuit 46a, and a second matching circuit 46b.

The first transmission circuit 43a and second transmission circuit 43b output the modulated signal that is modulated by the data signal output from the controller 60. In this embodiment of the invention the first transmission circuit 43a outputs a modulated signal for a first ultrasonic signal. The second transmission circuit 43b outputs a modulated signal for a second ultrasonic signal. The first ultrasonic signal and second ultrasonic signal are further described below.

The first reception circuit 44a outputs the data signal demodulated from the modulated signal (the reproduced data signal) to the controller 60. The modulated signal input to the first reception circuit 44a is a signal transmitted from another dive computer 1. Similarly to the first reception circuit 44a, the second reception circuit 44b outputs a data signal demodulated from the modulated signal to the controller 60. The modulated signal input to the second reception circuit 44b is a signal sent from the transmitter 100.

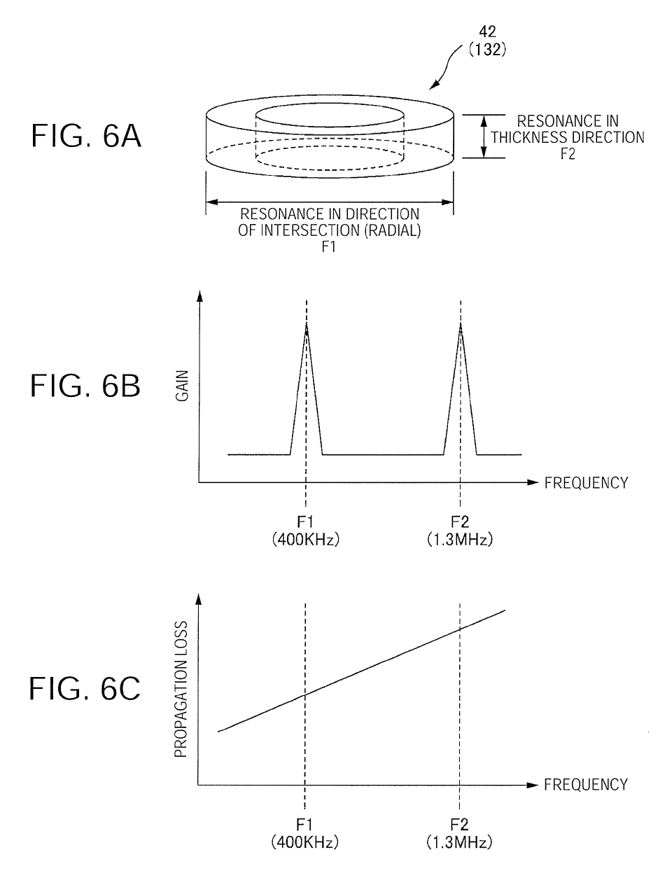

The first bandpass filter 45a passes a signal of a specific bandwidth that is set by the first resonance frequency F1 of the ultrasonic oscillator 42 (see FIG. 6B). The second bandpass filter 45b passes a signal of a specific bandwidth that is set by the second resonance frequency F2 of the ultrasonic oscillator 42 (see FIG. 6B).

The first matching circuit 46a matches the impedance of the circuit that handles signals of the first resonance frequency F1. The second matching circuit 46b matches the impedance of the circuit that handles signals of the second resonance frequency F2. Reflections caused by mismatched impedance are reduced by impedance matching. This can improve signal transmission and reception efficiency. In general, the impedance of the first resonance frequency F1 and the second resonance frequency F2 of the ultrasonic oscillator 42 differ. Using separate matching circuits 46a and 46b for resonance frequencies F1 and F2 is therefore extremely effective. This also contributes to improving separation between signals of the two frequencies F1 and F2.

The ultrasonic oscillator 42 is rendered by a ring-shaped piezoelectric device having a round hole passing through the center as shown in FIG. 6A, for example. The size of this ultrasonic oscillator 42 is 5 mm in diameter and 1 mm thick. As shown in FIG. 6B, this ultrasonic oscillator 42 has at least two resonance frequencies F1 and F2 that differ according to the oscillation mode. The first resonance frequency F1 is the resonance frequency of the radial oscillation mode, and the second resonance frequency F2 is the resonance frequency of the oscillation mode through the thickness of the ultrasonic oscillator 42. The radial direction is equivalent to a direction of intersection to the thickness direction (more specifically, perpendicularly thereto). Therefore, the first resonance frequency F1 is the resonance frequency of the oscillation mode in the direction of intersection. When the ultrasonic oscillator 42 is caused to operate based on the modulated signal output from the transmission circuit (first transmission circuit 43a, second transmission circuit 43b), a first ultrasonic signal of the first resonance frequency F1 and a second ultrasonic signal of the second resonance frequency F2 are transmitted from the ultrasonic oscillator 42. The ultrasonic oscillator 42 can also receive both the first ultrasonic signal and second ultrasonic signal.

The gain characteristic of the ultrasonic oscillator 42 (the characteristic denoting the conversion efficiency of electrical signals and ultrasonic signals) is set so that the gain of first resonance frequency F1 and the gain of second resonance frequency F2 are substantially equal. As a result, the transmission/reception efficiency of the first ultrasonic signal and second ultrasonic signal are equal.

In this embodiment of the invention the first resonance frequency F1 is 400 kHz, and the second resonance frequency F2 is 1.3 MHz. Because the first resonance frequency F1 is set to 400 kHz, the first bandpass filter 45a passes signals of a specific bandwidth centered on 400 kHz. Likewise, because the second resonance frequency F2 is set to 1.3 MHz, the second bandpass filter 45b passes signals of a specific bandwidth centered on 1.3 MHz. The difference between the center frequencies of the first resonance frequency F1 and second resonance frequency F2 is 900 kHz. As a result, the bandwidth required for transmission can be assured for the first ultrasonic signal and second ultrasonic signal while also providing sufficient signal separation.

Note that as shown in FIG. 6C the propagation loss of ultrasonic signals through water increases as the frequency rises. Therefore, if the second ultrasonic signal, which has a higher frequency than the first ultrasonic signal, is transmitted at the same signal strength, the distance that the second ultrasonic signal can be transmitted is shorter than the first ultrasonic signal.

As shown in FIG. 4, the ultrasonic oscillator 42 is contained in a metal package, for example, and is disposed to the 12:00 o'clock position on the front of the case CS1. More particularly, the ultrasonic oscillator 42 is disposed in the middle of the width (the line through the 3:00 o'clock and 9:00 o'clock positions) at the front top of the case CS1. This facilitates positioning the ultrasonic oscillators 42 for pairing.

The group including the first transmission circuit 43a, the second transmission circuit 43b, and ultrasonic oscillator 42 in the communication unit 40 is equivalent to a transmission unit for transmitting a first ultrasonic signal and a second ultrasonic signal of different frequencies. More particularly, the first transmission circuit 43a and ultrasonic oscillator 42 together are equivalent to a first transmission unit for transmitting the first ultrasonic signal, and the second transmission circuit 43b and ultrasonic oscillator 42 together are equivalent to a second transmission unit for transmitting the second ultrasonic signal.

In addition, the group including the first reception circuit 44a, the second reception circuit 44b, and the ultrasonic oscillator 42 is equivalent to a reception unit for receiving a first ultrasonic signal and a second ultrasonic signal of different frequencies. More particularly, the first reception circuit 44a and ultrasonic oscillator 42 together are equivalent to a first reception unit for receiving the first ultrasonic signal. Likewise, the second reception circuit 44b and ultrasonic oscillator 42 together are equivalent to a second reception unit for receiving the second ultrasonic signal.

The controller 60 handles output of data signals to the transmission circuits 43a and 43b, and handles receiving reproduced data signals from the reception units 44a and 44b.

### Transmitter 100

The transmitter 100 is described next. This transmitter 100 is a type of tank communication device, and is disposed to the valve 210 of the air tank 200 as shown in FIG. 8, for example. The transmitter 100 sends a data signal indicating the air pressure in the air tank 200 to the dive computer 1.

The electrical configuration of the transmitter 100 is similar to that of the dive computer 1. More specifically, as shown in FIG. 7, the transmitter 100 has an operating unit 110, a sensor group 120, a communication unit 130, and a controller 140. Each of these units has the same function as their counterparts in the dive computer 1. Briefly, the operating unit 110 is the unit that is manipulated to change the operating mode of the transmitter 100, for example, and includes an operating button 111 disposed to the case CS2 as shown in FIG. 8, for example.

The sensor group 120 includes a first pressure sensor 121, a second pressure sensor 122, and an in-water sensor 123. Like the pressure sensor 31 of the dive computer 1, the first pressure sensor 121 outputs a detection signal corresponding to the pressure of the environment around the transmitter 100. The second pressure sensor 122 outputs a detection signal corresponding to the gas pressure in the air tank 200. The in-water sensor 123 outputs a detection signal denoting if the transmitter 100 is in water.

The communication unit 130 exchanges data signals with the dive computer 1. The communication unit 130 has a communication circuit 131 and an ultrasonic oscillator 132. The communication circuit 131 includes a transmission circuit 133 and a reception circuit 134. The transmission circuit 133 outputs a modulated signal modulated by the data signal to the ultrasonic oscillator 132. The reception circuit 134 outputs the reproduced data signal to the controller 140.

The ultrasonic oscillator 132 oscillates based on the modulated signal, and outputs an ultrasonic signal. The resonance frequency of the ultrasonic oscillator 132 is set to the second resonance frequency F2 of the ultrasonic oscillator 42 in the dive computer 1. As shown in FIG. 6A, this ultrasonic oscillator 132 is also a circular ring-shaped oscillator with a hole in the center.

The communication circuit 131 shown in this example does not have a bandpass filter and matching circuit, but these may be included. Providing a bandpass filter and matching circuit enables removing unused frequency components, and improves data signal transmission and reception efficiency.

The controller 140 is the control center of the transmitter 100, and includes a CPU 141, memory 142, and a crystal oscillator 143. The CPU 141 operates according to firmware and controls the other controlled parts. The crystal oscillator 143 generates the reference clock of the transmitter 100. The controller 140 generates time information for the transmitter 100 based on this reference clock.

The transmitter 100 is attaced to the air tank 200. The transmitter 100 can thus be designed with greater freedom of size and shape than the dive computer 1 that is worn on the diver's wrist. The transmitter 100 can thus be rendered with a larger power supply than the dive computer 1, and ultrasonic signal output strength can be increased.

### Operation

The operation of this communication system is described next. As shown in FIG. 9, the first dive computer 1A worn by one diver communicates with the first transmitter 100A attaced to the first air tank 200A used by that diver and with the second dive computer 1B worn by another diver. The second dive computer 1B communicates with the second transmitter 100B attaced to the second air tank 200B worn by that diver, and with the first dive computer 1A. Both dive computers 1A and 1B display how much gas remains in the respective air tanks 200A and 200B.

Communication between the dive computers 1A and 1B and the corresponding transmitters 100A and 100B uses the second ultrasonic signal at the second resonance frequency F2, and communication between the dive computers 1A and 1B uses the first ultrasonic signal at the first resonance frequency F1. By thus communicating with the transmitter 100 using the second ultrasonic signal and communicating with another dive computer 1 using the first ultrasonic signal output from the ultrasonic oscillator 42 in the dive computer 1, the ultrasonic oscillator 42 can be used for both communication modes and the configuration of the communication system is simplified.

In order to communicate in this way, each diver pairs his dive computer with each of the other devices either on land or on the surface vessel (that is, in air). More specifically, the first diver pairs his first dive computer 1A with the first transmitter 100A, and the other diver pairs the second dive computer 1B with the second transmitter 100B. The first diver and the other diver then also pair the first dive computer 1A and the second dive computer 1B.

This pairing operation is described briefly. Pairing the dive computer 1 and transmitter 100 is described first. For this operation the ultrasonic oscillator 42 of the dive computer 1 (1A, 1B) and the ultrasonic oscillator 132 of the transmitter 100 (100A, 100B) are set facing each other as shown in FIG. 10A, the transmitter 100 is set to the reception mode, and the dive computer 1 is set to the transmission mode. Pairing data (a type of data signal) is then transmitted from the dive computer 1. More specifically, the second ultrasonic signal is modulated to transmit the pairing data. When this pairing data is received, the transmitter 100 returns a response (acknowledge signal) indicating that the pairing data was received, and sends the receiver-side pairing data. This response is sent by modulating the second ultrasonic signal. Pairing ends with this response. By thus exchanging time and pace information, the time and clocks can be synchronized. The timing for communication between devices is also set.

Pairing the dive computers 1A and 1B is done in the same way. In this case, however, as shown in FIG. 10B, the first dive computer 1A and second dive computer 1B are set so that the ultrasonic oscillators 42 face each other, and the first dive computer 1A sends pairing data to the second dive computer 1B. More specifically, the first ultrasonic signal is modulated to transmit the pairing data. In addition to acknowledging that the pairing data was received, the second dive computer 1B returns its pairing data. This response is also sent by modulating the first ultrasonic signal. By thus exchanging time and pace information, the time and clocks can be synchronized. The timing for communication between devices is also set.

Note that the speed of ultrasonic waves in air is slower than through water. As a result, the precision of the time synchronized by this pairing process can be improved by enabling the communicating devices to communicate at a short distance of several centimeters to several ten centimeters.

The devices that were paired above water through air communicate with each other underwater. The devices therefore start communication conditionally upon being in water. The controllers 60 of the dive computers 1A and 1B and the controllers 140 of the transmitters 100A and 100B therefore confirm that they are underwater and the water pressure based on the output from the in-water sensors 32, 123 and the pressure sensors 31, 121, and start communication if the conditions are satisfied. This communication starts at the timing set when the devices were paired. Communication in this communication system occurs in a half-duplex mode.

The time required for communication between the dive computers 1A and 1B and corresponding transmitters 100A and 100B (that is, the communication time for acquiring the residual gas level in the air tank 200) is shorter than the time required for communication between the dive computers 1A and 1B. The dive computers 1A and 1B may also communicate with the transmitters 100A and 100B intermittently. As a result, communication between the dive computers 1A and 1B may be stopped during communication between the dive computers 1A and 1B and corresponding transmitters 100A and 100B. This can reliably prevent interference between the two frequencies.

Efficiency is good in this communication system because the lower second ultrasonic signal (second resonance frequency F2), which attenuates easily through water, is used for communication between the transmitter 100 and dive computer 1. More specifically, because the second ultrasonic signal with a relatively short communication distance is used for communication with the transmitter 100, for which the communication distance tends to be short, and the first ultrasonic signal with a relatively long transmission distance is used for communication with the other dive computer 1, which tends to be at a longer communication distance, the devices can communicate efficiently by using the characteristics of the ultrasonic signals appropriately. In addition, the communication unit 130 of the transmitter 100 can easily be made larger than the communication unit 40 of the dive computer 1. As a result, signal attenuation through water can be easily compensated for by increasing the output level of the communication unit 130.

It should also be noted that, depending upon the positions of the divers, the second ultrasonic signal could be received from the transmitter 100 attaced to the air tank 200 of the other diver. To prevent this problem, the timing when the second ultrasonic signal is transmitted from the first transmitter 100A and the timing when the second ultrasonic signal is transmitted from the second transmitter 100B can be mutually offset. This enables each of the dive computers 1A and 1B to selectively receive the data each dive computer should use based on the timing at which the second ultrasonic signal is transmitted. Problems caused by accidentally receiving the residual gas level for the other diver's air tank 200 can therefore be prevented.

### Conclusion

The following conclusions can be drawn from the foregoing description.

First, because each of the dive computers 1A and 1B has an ultrasonic oscillator 42 that outputs at least two resonance frequencies F1 and F2 according to the oscillation mode, communicates with a transmitter 100 (tank) using one resonance frequency F2, and communicates with the other dive computer 1 using the other resonance frequency F1, a single ultrasonic oscillator 42 can be shared for both communication modes, and the device configuration can be simplified.

Furthermore, because the resonance frequency of the oscillation mode in the thickness direction of the ultrasonic oscillator 42 and the resonance frequency of the oscillation mode in the intersecting direction are used, a sufficient frequency difference between the first ultrasonic signal and the second ultrasonic signal can be assured and both can be used for reliable communication with the companion communication device.

Furthermore, because the resonance frequency of the oscillation mode in the thickness direction is higher than the resonance frequency of the oscillation mode in the intersecting direction, the thickness of the ultrasonic oscillator 42 can be made thinner to help reduce device size. The communication unit 40 of the dive computer 1 can also communicate with the transmitter 100 using the higher frequency of the two resonance frequencies. Because the transmitter 100 is typically closer than the dive computer 1 of the other diver, the transmitter 100 can communicate efficiently by using the characteristics of the ultrasonic signals appropriately by using the higher frequency that attenuates easily.

### Other Embodiments

The foregoing embodiments of the invention are described primarily with reference to a communication system, but also include disclosure of a communication device for divers, a computer program and code used by the divers communication device, a storage medium storing the program, a method of displaying the residual tank capacity in data communication for divers, an emergency reporting method, a synchronization method, and a communication method.

A communication system is also described as another embodiment of the invention, but this embodiment is used to simplify understanding of the invention and is not for limiting understanding the invention. It will be obvious to one with ordinary skill in the related art that the invention can be modified and improved in many ways without departing from the scope of the accompanying claims, and all equivalent renderings are included in the scope of the present invention.

More particularly, the embodiments described below are also included in the scope of the invention.

### Gain Characteristic

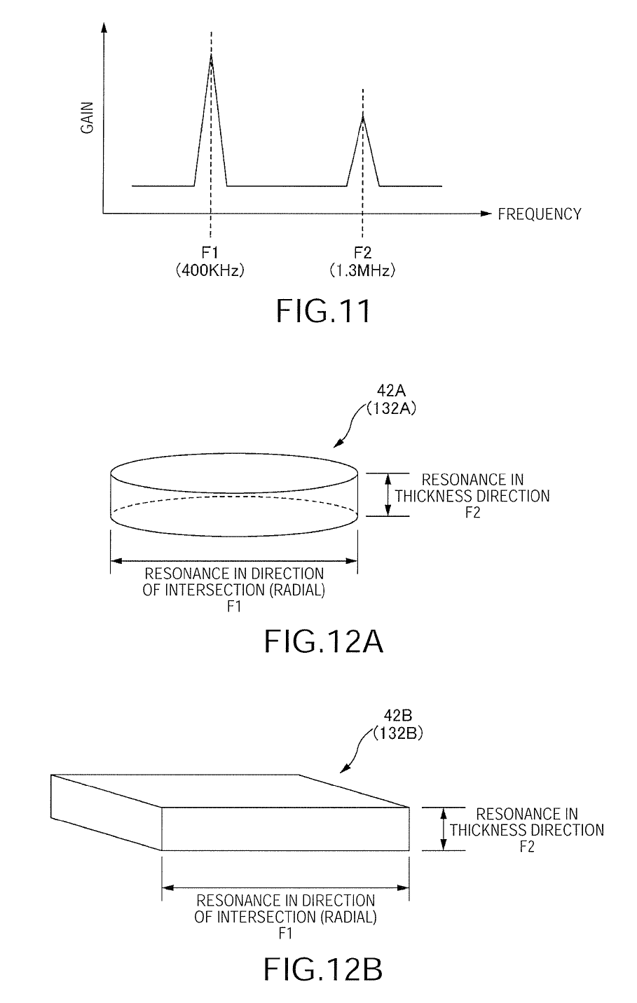

The gain of the first resonance frequency F1 and the gain of the FIG. 2 are substantially equal in the embodiments described above, but gain may differ depending upon the shape of the ultrasonic oscillator 42. In this case the resonance frequency with the lower gain is used for communication with the transmitter 100 (air tank 200) For example, in the gain characteristic of the ultrasonic oscillator 42 shown in FIG. 11, the gain of the second resonance frequency F2 is lower than the gain of the first resonance frequency F1. As a result, the second resonance frequency F2 is used for communication with the air tank 200, and the first resonance frequency F1 is used for communication with the other dive computer 1. The gain of the first resonance frequency F1 may also be lower than the gain of the second resonance frequency F2. In this case, the first resonance frequency F1 is used for communication with the air tank 200, and the second resonance frequency F2 is used for communication with the other dive computer 1.

### Ultrasonic Oscillator 42, 132

The shape of the ultrasonic oscillator 42, 132 is not limited to a circular ring as described above. For example, as shown in FIG. 12A, the ultrasonic oscillator 42, 132 may have a simple disc shape, or the ultrasonic oscillator 42, 132 may be a rectangular plate as shown in FIG. 12B. Further alternatively, it may be a round column or a rectangular column.

A second, third, or higher order oscillation mode may also be used for the ultrasonic wave.

### Communication Mode

The foregoing embodiments are described using half-duplex communication, but full-duplex communication can be enabled by adding another set of communication units 40, 130 with different resonance frequencies.

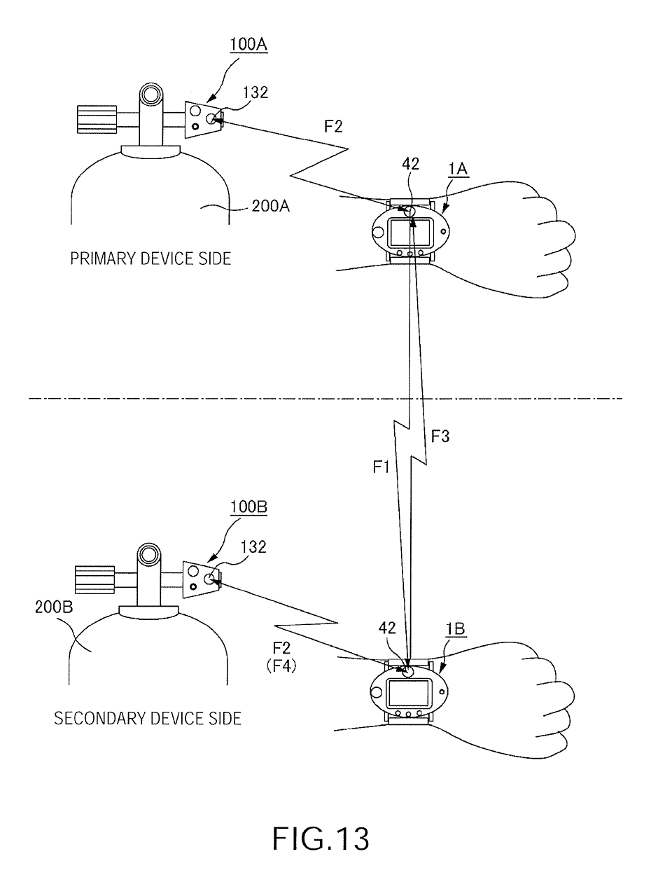

For example, as shown in FIG. 13, the first ultrasonic signal at the first resonance frequency F1 could be used for communication from the first dive computer 1A to the second dive computer 1B, and the second ultrasonic signal at the second resonance frequency F2 could be used for communication between the first transmitter 100A and the first dive computer 1A. In addition, a third ultrasonic signal at a third resonance frequency F3 could be used for communication from the second dive computer 1B to the first dive computer 1A, and the second ultrasonic signal could be used for communication between the second transmitter 100B and the second dive computer 1B. In this configuration a fourth ultrasonic signal at a fourth resonance frequency F4 could also be used for communication between the second transmitter 100B and the second dive computer 1B.

### Number of Other Divers

The foregoing embodiments are described with two divers (one other diver) by way of example. However, there could be two or more other divers. More specifically, information for three or more people including oneself may be displayed on the display unit 10.

### Communication Device for Divers

A dive computer 1 is described by way of example as a communication device for divers in the foregoing embodiments, but the invention is not so limited. More particularly, any devices that are worn by each diver and enable wireless communication between devices will be a communication device for divers.

### Third Embodiment

A third embodiment of the invention is described below as an embodiment of the fourth aspect of the invention described above. Unlike the first and second embodiments described above, this third embodiment is characterized by using an ultrasonic signal in an application for measuring distance instead of a communication application. An application of the invention in a device that detects an obstacle behind a motor vehicle is described below.

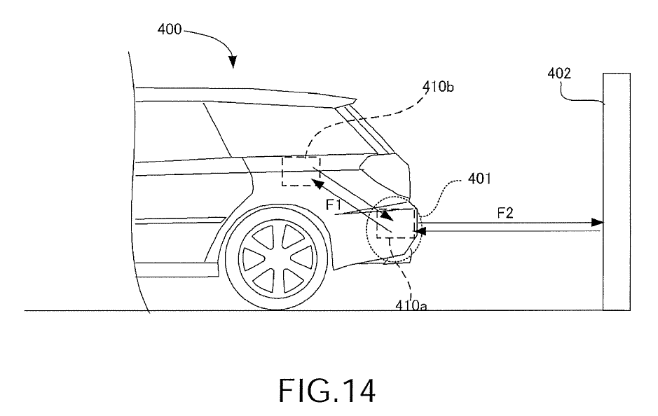

FIG. 14 is a schematic view of an ultrasonic signal transmitter/receiver device according to a third embodiment of the invention. This ultrasonic signal transmitter/receiver device 410a is an application of a dinstance-gauging device for a motor vehicle. Dinstance-gauging devices in most motor vehicles are used to measure the distance to obstacles in the dead angle behind the vehicle, operate when the transmission is put into reverse, transmit an ultrasonic signal at one frequency F2 from an ultrasonic oscillator built-in to the rear bumper 401 of the vehicle 400, for example, measure the time until the transmitted signal is reflected by an obstacle and is picked up by the ultrasonic oscillator, calculate the distance to the obstacle 402 based on this time and the speed of sound in air, and display the distance or audibly announce the distance by voice synthesis.

Similarly to the first and second embodiments described above, the ultrasonic signal transmitter/receiver device 410a in this third embodiment of the invention can transmit and receive two different ultrasonic signals from a single ultrasonic oscillator, and in this embodiment transmits information including the calculated distance to another device using an ultrasonic signal at a frequency F1 that differs from the foregoing frequency F2.

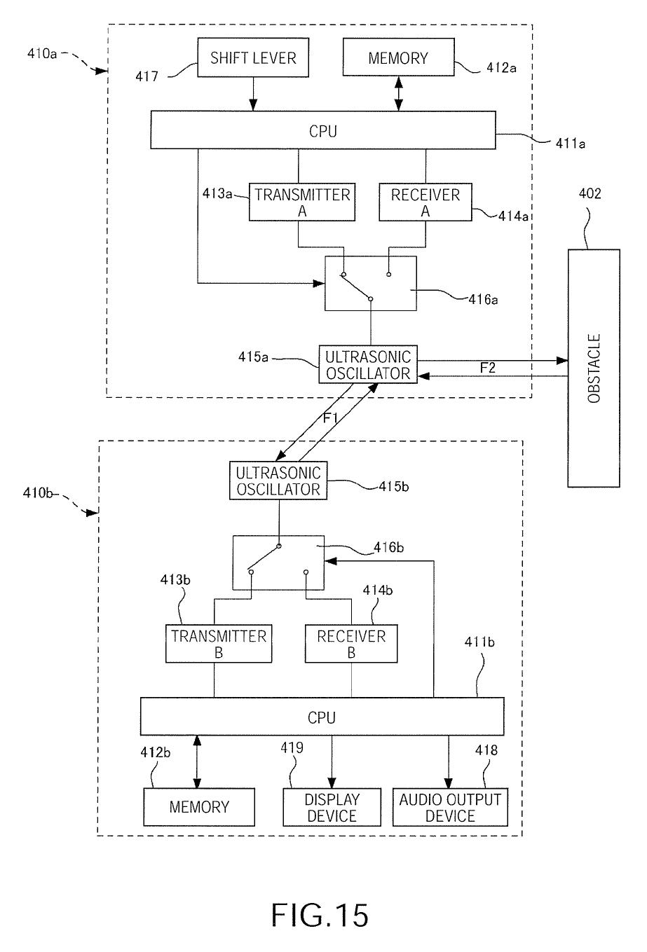

FIG. 15 is a function block diagram of the ultrasonic signal transmitter/receiver device 410a, and another communication device 410b that communicates information with the ultrasonic signal transmitter/receiver device 410a. A computer including a CPU 411a and memory 412a is used as a controller. A transmitter A 413a drives an ultrasonic oscillator 415a as controlled by the CPU 411a, and transmits an ultrasonic signal at frequency F1 or F2. The receiver A 414a includes a demodulation circuit for demodulating the ultrasonic signal of frequency F1 or F2 received by the ultrasonic oscillator 415a, and an A/D conversion circuit for converting the demodulated signal, and inputs digital data based on the demodulated signal to the CPU 411a. A switch 416a switches the signal path to the ultrasonic oscillator 415a to the transmitter A 413a side or the receiver A 414a side as controlled by the CPU 411a. When a signal indicating that the shift lever 417 was moved to reverse is input from a switch, for example, linked to operation of the shift lever 417, the CPU 411a activates the ultrasonic signal transmitter/receiver device 410a, switches the switch 416a to the transmitter A 413a side, transmits an ultrasonic signal of frequency F2 that includes the current time information to the transmitter A 413a, and causes the switch 416a to switch immediately to the receiver A 414a side.

The ultrasonic signal reflected by the obstacle 402 is input through the ultrasonic oscillator 415a to the receiver A 414a, and the digital data in the signal is input to the CPU 411a. The CPU 411a compares the time information contained in the reflected signal with the current time, and calculates the distance to the obstacle 402 from this time difference. The switch 416a is then switched to the transmitter A 413a side, and the calculated result is transmitted to the ultrasonic oscillator 415a at frequency F1.

The device 410b that receives the second ultrasonic signal including the distance information sent at frequency F1 is an on-board communication device, and is conceivably a navigation device, for example, with an ultrasonic signal reception function. The parts of the on-board communication device 410b that send and receive the ultrasonic signals are substantially identical to the ultrasonic signal transmitter/receiver device 410a, and include an ultrasonic oscillator 415b, a transmitter B 413b, a receiver B 414b, a switch 416b for switching the signal path, and a controller including a CPU 411b and memory 412b for controlling the on-board communication device 410b.

When an ultrasonic signal of frequency F1 from the ultrasonic signal transmitter/receiver device 410a is received through the ultrasonic oscillator 415b and receiver B 414b connected thereto, the CPU 411b of the on-board communication device 410b returns acknowledgment of reception to the ultrasonic signal transmitter/receiver device 410a side by means of the transmitter B 413b and ultrasonic oscillator 415b, and reports the distance to the obstacle 402 to the driver by outputting the distance information in the ultrasonic signal from the ultrasonic signal transmitter/receiver device 410a on the display device 419, such as a monitor, or outputting to an audio output device 418 that has a speaker for beeping according to the distance to the obstacle 402 or outputting audio guidance generated by voice synthesis.

By repeating the entire process from the CPU 411a of the ultrasonic signal transmitter/receiver device 410a transmitting an ultrasonic signal containing time information to receiving reception acknowledgment from the on-board communication device 410b at high speed, the distance can be continuously updated, the updated information can be transmitted using an ultrasonic signal of frequency F2, and the on-board communication device 410b can visibly display or audibly output information relating to the distance in real time.

The ultrasonic signal transmitter/receiver device 410a and the on-board communication device 410b that communicate therewith at frequency F1 communicate information wirelessly by means of ultrasonic signals, and do not need any hard wiring to connect the two devices (410a, 410b). As a result, there is great flexibility determining where the on-board communication device 410b is located, regardless of vehicle make or model. Note that in a dinstance-gauging application such as this distance is preferably measured using a high frequency with outstanding directivity. More specifically, F2>F1. Furthermore, by using an easily diffracted, low-frequency ultrasonic signal for internal communication between the ultrasonic signal transmitter/receiver device 410a and on-board communication device 410b, information can be communicated reliably even if there is not a direct line of sight between these devices (411a, 411b).

### Other Embodiments

Specific embodiments of an ultrasonic communication device according to the present invention are not limited to the first to third embodiments described above. For example, while the first and second embodiments are described as underwater communication devices, the devices described in these embodiments can also be used for communication through air. The dinstance-gauging application described in the third embodiment is also not limited to communication through air. For example, the dive computer carried by one diver could measure the distance to the dive computer carried by another diver while underwater, and transmit this distance information to a communication device on the surface vessel. Alternatively, an ultrasonic signal containing a command for measuring the distance to the other dive computer could be sent from the communication device on the surface vessel to a specific dive computer, and that specific dive computer could then measure the distance to the dive computer of the other diver and then transmit this distance to the device on the surface vessel. The invention can thus be used for information communication applications or dinstance-gauging applications in air or in water.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

The entire disclosure of Japanese Patent Application Nos: 2008-123019, filed May 9, 2008; 2008-175355, filed Jul. 4, 2008; and 2009-033592, filed Feb. 17, 2009 are expressly incorporated by reference herein.

What is claimed is:

1. An ultrasonic signal communication device comprising:
an ultrasonic oscillation unit that has at least two resonance frequencies according to the oscillation mode;
a transmission unit that generates a first ultrasonic signal at one of the two resonance frequencies and transmits the generated first ultrasonic signal from the ultrasonic oscillation unit; and
a reception unit that receives a second ultrasonic signal that is transmitted at the other of the two resonance frequencies from the ultrasonic oscillation unit.

2. A communication device wherein the ultrasonic signal communication device described in claim 1 is a communication device, the first ultrasonic signal and the second ultrasonic signal are communication signals, and the communication device comprises a control unit that asynchronously controls transmission by the first transmission unit and reception by the reception unit.

3. The communication device described in claim 2, comprising a filter unit that selectively passes a signal of a specific frequency band at least between the ultrasonic oscillation unit and the transmission unit, or between the ultrasonic oscillation unit and the reception unit.

4. The communication device described in claim 2, comprising:
a matching unit that matches impedance at least between the ultrasonic oscillation unit and the transmission unit, or between the ultrasonic oscillation unit and the reception unit.

5. The ultrasonic signal communication device described in claim 1, further comprising:
a second reception unit that receives the first ultrasonic signal from the ultrasonic oscillation unit; and
a second transmission unit that transmits the second ultrasonic signal by means of the ultrasonic oscillation unit.

6. A communication device wherein the ultrasonic signal communication device described in claim 5 is a communication device, the first ultrasonic signal and the second ultrasonic signal are communication signals, and the communication device comprises a communication unit that communicates with a different type of communication device than said communication device using one of the resonance frequencies, and communicates with a communication device of the same type as said communication device using the other resonance frequency.

7. The communication device described in claim 6, wherein the communication unit communicates using a resonance frequency of an oscillation mode in the thickness direction of the ultrasonic oscillation unit and a resonance frequency of an oscillation mode in a direction of intersection intersecting the thickness direction.

8. The communication device described in claim 7, wherein the resonance frequency of the oscillation mode in the thickness direction is higher than the resonance frequency of the oscillation mode in the direction of intersection.

9. The communication device described in claim 6, wherein the communication unit uses the resonance frequency with the lower gain characteristic of the two resonance frequencies for communication at a shorter distance.

10. A divers communication device wherein the communication device described in claim 6 is a divers communication device, and the communication unit communicates with a tank using one resonance frequency and communicates with another divers communication device using the other resonance frequency.

11. The divers communication device described in claim 10, wherein the communication unit communicates with the tank using the resonance frequency with the lower gain characteristic of the two resonance frequencies.

12. The divers communication device described in claim 10, further comprising a display unit that displays residual amount information sent from the tank and residual amount information sent through the other divers communication device.

13. A communication system for communicating between a plurality of communication devices, wherein:
one communication device comprises
an ultrasonic oscillation unit that has at least two resonance frequencies according to the oscillation mode,
a transmission unit that generates a first communication signal at one of the two resonance frequencies and transmits the generated first communication signal from the ultrasonic oscillation unit, and
a reception unit that receives a second communication signal that is transmitted at the other of the two resonance frequencies from the ultrasonic oscillation unit; and
another communication device comprises
an ultrasonic oscillation unit that has at least the two resonance frequencies according to the oscillation mode,
a transmission unit that generates the second communication signal at the other of the two resonance frequencies and transmits the generated second communication signal from the ultrasonic oscillation unit, and
a reception unit that receives the first communication signal that is transmitted at the one of the two resonance frequencies from the ultrasonic oscillation unit.

14. The communication system described in claim 13, wherein, of the two resonance frequencies, the gain characteristic of one frequency is lower than the gain characteristic of the other frequency, and the one communication device has a higher signal output level than the other communication device.

15. The communication system described in claim 13, wherein, of the two resonance frequencies, the propagation loss of one frequency is greater than the propagation loss of the other frequency, and the one communication device has a higher signal output level than the other communication device.

16. A communication method comprising:
a transmission step of generating a first communication signal and transmitting the generated first communication signal from one ultrasonic oscillation unit at one frequency of two resonance frequencies corresponding to the oscillation modes of the ultrasonic oscillation unit; and
a reception step of receiving a second communication signal transmitted at the other frequency of the two resonance frequencies from the ultrasonic oscillation unit.

17. A communication system comprising a tank communication device attached to a tank, and a divers communication device worn by a diver, wherein
the divers communication device has
an ultrasonic oscillation unit that has at least two resonance frequencies corresponding to the oscillation modes; and
a communication unit that communicates with the tank communication device using one resonance frequency of the two resonance frequencies, and communicates with another divers communication device using the other resonance frequency of the two resonance frequencies.

18. A communication method for communicating between a divers communication device worn by one diver, a tank used by the one diver, and another divers communication device worn by another diver, wherein:
communication with the tank uses one resonance frequency of the at least two resonance frequencies produced by an ultrasonic oscillation unit; and
communication with the other divers communication device uses the other resonance frequency of the two resonance frequencies.

19. The ultrasonic signal communication device described in claim 1, comprising:
a distance-gauging unit that measures the distance to a transmission signal source based on a time difference between when the second ultrasonic signal is transmitted and when the second ultrasonic signal is received by the reception unit.

20. The ultrasonic signal communication device described in claim 19, comprising:
a second transmission unit that transmits the second ultrasonic signal by means of the ultrasonic oscillation unit; and
a transmission/reception switching unit that switches between a transmission process of transmitting the second ultrasonic signal by means of the second transmission unit, and a reception process of receiving the second ultrasonic signal by means of the reception unit.
